(19) United States
(12) Patent Application Publication
(10) Pub. No.: US 2004/0034531 A1
(43) Pub. Date: Feb. 19, 2004

(54) Distributed multimodal dialogue system and method

(76) Inventors: Wu Chou, Bridgewater, NJ (US); Li Ll, Bridgewater, NJ (US); Feng Liu, Raritan, NJ (US); Antoine Saad, Edison, NJ (US)

Correspondence Address: BIRCH STEWART KOLASCH & BIRCH, PO BOX 747, FALLS CHURCH, VA, 22040-0747, US

(21) Appl. No.: 10/218,608

(22) Filed: Aug. 15, 2002

(51) Int. Cl. G10L 21/00

(52) U.S. Cl. 704/270.1

(57) ABSTRACT

A system and method for providing distributed multimodal interaction are provided. The system is a hybrid multimodal dialogue system that includes one or multiple hybrid constructs to form sequential and joint events in multimodal interaction. It includes an application interface receiving a multimodal interaction request for conducting a multimodal interaction over at least two different modality channels; and at least one hybrid construct communicating with multimodal servers corresponding to the multiple modality channels to execute the multimodal interaction request.

### BACKGROUND OF THE INVENTION

1. Field of the Invention

The invention relates to techniques of providing a distributed multimodal dialogue system in which multimodal communications and/or dialogue types can be integrated into one dialogue process or into multiple parallel dialogue processes as desired.

2. Discussion of the Related Art

Voice Extensible Markup Language or VoiceXML is a standard set by World Wide Web Committee (W3C) and allows users to interact with the Web through voice-recognizing applications. Using VoiceXML, a user can access the Web or application by speaking certain commands through a voice browser or a telephone line. The user interacts with the Web or application by entering commands or data using the user's natural voice. The interaction or dialogue between the user and the system is over a single channel—voice channel. One of the assumptions underlying such VoiceXML-based systems is that a communication between a user and the system through a telephone line follows a single modality communication model where events or communications occur sequentially in time as in a stream line synchronized process.

However, conventional VoiceXML systems using the single modality communication model are not suitable for multimodal interactions where multiple communication processes need to occur in parallel over different modes of communication (modality channels) such as voice, e-mail, fax, web form, etc. More specifically, the single modality communication model of the conventional VoiceXML systems is no longer adequate for use in a multimodal interaction because it follows a stream line synchronous communication model.

In a multimodal interaction system, the following four level hierarchies of various types of multimodal interactions, which cannot be provided by a single streamline modality communication of the related art, would be desired:

(Level 1) Sequential Multimodal Interaction: Although the system would allow multiple modalities or modes of communication, only one modality is active at any given time instant, and two or more modalities are never active simultaneously.

(Level 2) Uncoordinated, Simultaneous Multimodal Interaction: The system would allow a concurrent activation of more than one modality. However, if an input needs to be provided by more than one modality, such inputs are not integrated, but are processed in isolation, in random or specified order.

(Level 3) Coordinated, Simultaneous Multimodal Interaction: The system would allow a concurrent activation of more than one modality for integration and forms joint events based on time stamping or other process synchronization information to combine multiple inputs from multiple modalities.

(Level 4) Collaborative, Information-overlay-based Multimodal Interaction: In addition to Level 3 above, the interaction provided by the system would utilize a common shared multimodal environment (e.g., white board, shared web page, and game console) for multimodal collaboration, thereby allowing collaborative interaction be shared and overlaid on top of each other with the common collaborating environment.

Each level up in the hierarchy above represents a new challenge for dialogue system design and departs farther away from the single modality communication by an existing voice model. Thus, if a multimodal communication is desired, i.e., if interaction through multiple modes of communication is desired, new approaches are needed.

### SUMMARY OF THE INVENTION

The present invention provides a method and system for providing distributed multimodal interaction, which overcome the above-identified problems and limitations of the related art. The system of the present invention is a hybrid VoiceXML dialogue system, and includes an application interface receiving a multimodal interaction request for conducting a multimodal interaction over at least two different modality channels; and at least one hybrid construct communicating with multimodal servers corresponding to the multiple modality channels to execute the multimodal interaction request.

Advantages of the present invention will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus do not limit the present invention.

FIG. 1 is a functional block diagram of a system for providing distributed multimodal communications according to an embodiment of the present invention;

FIG. 2 is a more detailed block diagram of a part of the system of FIG. 1 according to an embodiment of the present invention; and

FIG. 3 is a function block diagram of a system for providing distributed multimodal communications according to an embodiment of the present invention, wherein it is adapted for integrating finite-state dialogue and natural language dialogue.

### DETAILED DESCRIPTION OF THE PREFERRED EMBODIMENTS

The use of the term “dialogue” herein is not limited to voice dialogue, but is intended to cover a dialoging or interaction between multiple entities using any modality channel including voice, e-mail, fax, web form, documents, web chat, etc. Same reference numerals are used in the drawings to represent the same or like parts.

Generally, a distributed multimodal dialogue system according to the present invention follows a known three-tier client-server architecture. The first layer of the system is the physical resource tier such as a telephone server, internet protocol (IP) terminal, etc. The second layer of the system is the application program interface (API) tier, which wraps all the physical resources of the first tier as APIs. These APIs are exposed to the third, top-level application tier for dialogue applications. The present invention focuses on the top application layer by modifying it to support multimodal interaction. This configuration provides an extensible and flexible environment for application development so that any new issues, current and potentially future ones, can be addressed without requiring extensive modifications to the existing infrastructure. It also provides sharable cross multiple platforms with reusable and distributed components that are not tied to specific platforms. In this process, although not necessary, VoiceXML may be used as its voice modality if voice dialogue is involved as one of the multiple modalities involved.

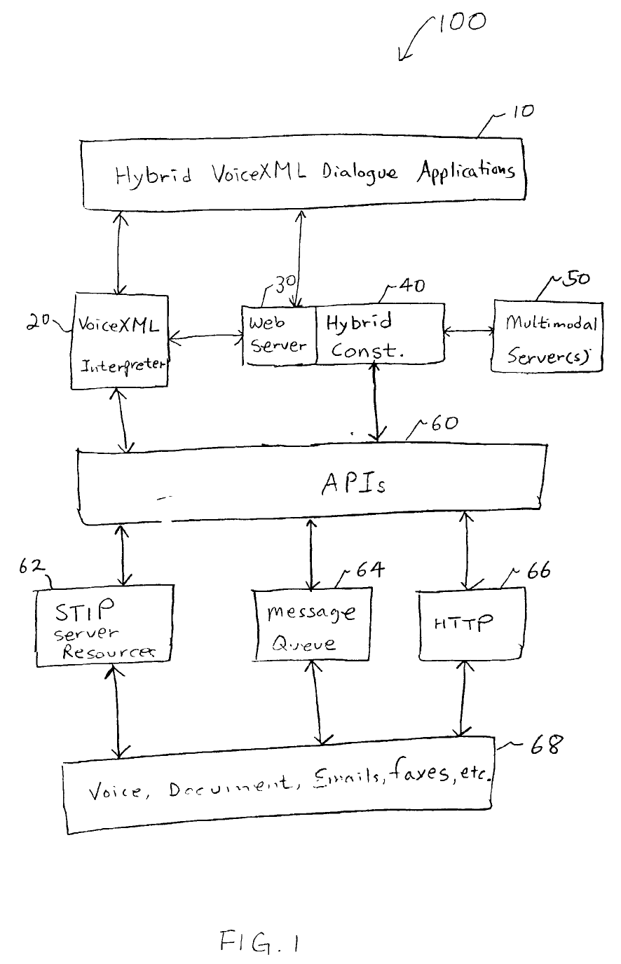

FIG. 1 is a functional block diagram of a dialogue system 100 for providing distributed multimodal communications according to an embodiment of the present invention. As shown in FIG. 1, the dialogue system 100 employs components for multimodal interaction including hybrid VoiceXML based dialogue applications 10 for controlling multimodal interactions, a VoiceXML interpreter 20, application program interfaces (APIs) 60, speech technology integration platform (STIP) server resources 62, and a message queue 64, and a server such as HyperText Transfer Protocol (HTTP) server 66. The STIP server resources 62, the message queue 64 and the HTTP 66 receive inputs 68 of various modalities such as voice, documents, e-mails, faxes, web-forms, etc.

The hybrid VoiceXML based dialogue applications 10 are multimodal, multimedia dialogue applications such as multimodal interaction for direction assistance, customer relation management, etc., and the VoiceXML interpreter 20 is a voice browser known in the art. VoiceXML products such as VoiceXML 2.0 System (Interactive Voice Response 9.0) from Avaya Inc. would provide these known components.

The operation of each of the components 20, 60, 62, 64 and 66 is known in the art. For instance, the resources needed to support voice dialogue interactions are provided in the STIP server resources 62. Such resources include, but are not limited to, multiple ports of automatic speech recognition (ASR), text-to-speech engine (TTS), etc. Thus, when a voice dialogue is involved, a voice command from a user would be processed by the STIP server resources 62, e.g., converted into text information. The processed information is then processed (under the dialogue application control and management provided by the dialogue applications 10) through the APIs 60 and VoiceXML interpreter 20. The message queue 64, HTTP 66 and socket or other connections are used to form an interface communication tier to communicate with external devices. These multimodal resources are exposed through the APIs 60 to the application tier of the system (platform) to communicate with the VoiceXML interpreter 20 and the multimodal hybrid-VoiceXML dialogue applications 10.

More importantly, the dialogue system 100 further includes a web server 30, a hybrid construct 40, and multimodal server(s) 50. The hybrid construct 40 is an important part of the dialogue system 100 and allows the platform to integrate distributed multimodal resources which may not physically reside on the platform. In another embodiment, multiple hybrid constructs 40 may be provided to perform sets of multiple multimodal interactions either in parallel or in some sequence, as needed. These components of the system 100, including the hybrid construct(s) 40, are implemented as computer software using known computer programming languages.

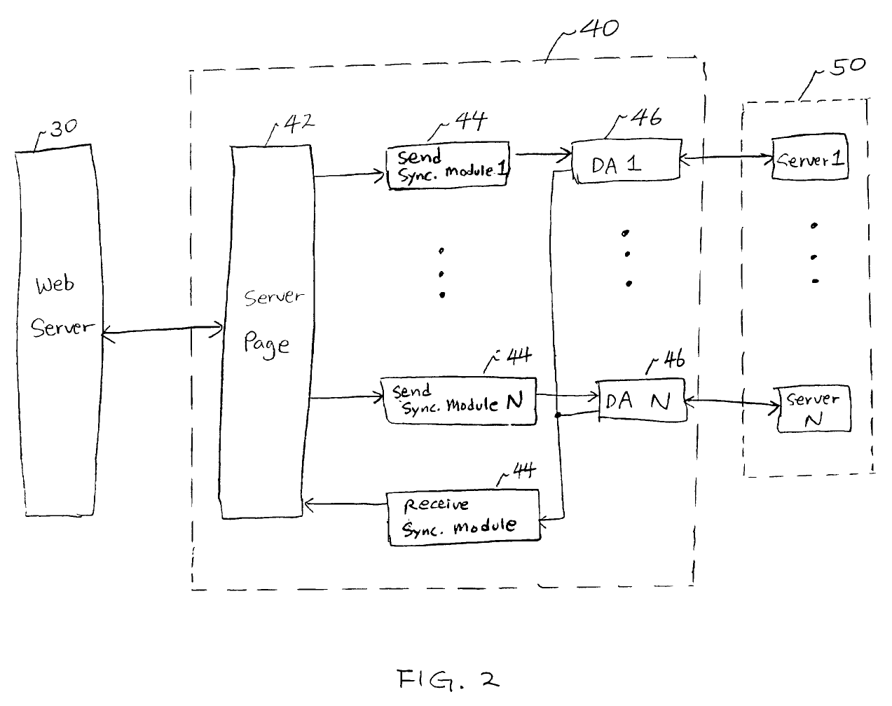

FIG. 2 is a more detailed block diagram showing the hybrid construct 40. As shown in FIG. 2, the hybrid construct 40 includes a server page 42 interacting with the web server 30, a plurality of synchronizing modules 44, and a plurality of dialogue agents (DAs) 46 communicating with a plurality of multimodal servers 50. The sever page 42 can be a known server page such as active server page (ASP) or java server page (JSP). The synchronizing modules 44 can be known message queues (e.g., sync threads, etc.) used for asynchronous-type synchronization such as for e-mail processing, or can be function calls known for non-asynchronous type synchronization such as for voice processing.

The multimodal servers 50 include servers capable of communication over different modes of communication (modality channels). The multimodal servers 50 may include, but are not limited to, one or multiple e-mail servers, one or multiple fax servers, one or multiple web-form servers, one or multiple voice servers, etc. The synchronizing modules 44 and the DAs 46 are designated to communicate with the multimodal servers 50 such that the server page 42 has information on which synchronizing module and/or DA should be used to get to a particular type of the multimodal server 50. The server page 42 prestores and/or preassigns this information.

An operation of the dialogue system 100 is as follows.

The system 100 can receive and process different multiple modal communication requests either simultaneously or sequentially in some random or sequenced manner, as needed. For example, the system 100 can conduct multimodal interaction simultaneously using three modalities (three modality channels)—voice channel, email channel and web channel. In this case, a user may use voice (voice channel) to activate other modality communications such as e-mail and web channel, such that the user can begin dialogue actions over the three (voice, e-mail and web) modality channels in a parallel, sequenced or collaborated processing manner.

The system 100 can also allow cross-channel, multimedia multimodal interaction. For instance, a voice interaction response that uses the voice channel can be converted into text using known automatic speech recognition techniques (e.g., via the ASR of the STIP server resources 62), and can be submitted to a web or email channel through the web server 30 for a web/email channel interaction. The web/email channel interaction can also be converted easily into voice using the TTS of the STIP server resources 62 for the voice channel interaction. These multimodal interactions, including the cross-channel and non cross-channel interactions, can occur simultaneously or in some other manner as requested by a user or according to some preset criteria.

Although a voice channel is one of main modality channels often used by end-users, multimodal interaction that does not include the use of the voice channel is also possible. In such a case, the system 100 would not need to use voice channel and the voice channel related STIP server resources 62, and the hybrid construct 40 would communicate directly with the APIs 60.

In the operation of the system 100 according to one example of application, when the system 100 receives a plurality of different modality communication requests either simultaneously or in some other manner, they would be processed by one or more of the STIP server resources 62, message queue 64, HTTP 66, APIs 60, and VoiceXML interpreter 20, and the multimodal dialogue applications 10 will be launched to control the multimodal interactions. If one of the modalities of this interaction involves voice (voice channel), then STIP server resources 62 and the VoiceXML interpreter 20, under control of the dialogue applications 10, would be used in addition to other components as needed. On the other hand, if none of the modalities of this interaction involves voice, then the components 20 and 62 may not be needed.

The multimodal dialogue applications 10 can communicate interaction requests to the hybrid construct 40 either through the VoiceXML interpreter 20 or through the web server 30 (e.g., if the voice channel is not used). Then the server page 42 of the hybrid construct 40 is activated so that it formats or packs these requests into ‘messages’ to be processed by the requested multimodal servers 50. A ‘message’ here is a specially formatted information bearing data packet, and the formatting/packing of the request involves embedding the appropriate request into a special data packet. The server page 42 then sends these messages simultaneously to the corresponding synchronizing modules 44 depending on the information indicating which synchronizing module 44 is designated to serve a particular modality channel. Then the synchronizing modules 44 may temporarily store the messages and send the messages to the corresponding DAs 46 when they are ready.

When each of the corresponding DAs 46 receives the corresponding message, it unpacks the message to access the request, translates the request into a predetermined proper format recognizable by the corresponding multimodal server 50, and sends the request in the proper format to the corresponding server 50 for interaction. Then each of the corresponding servers 50 receives the request and generates a response to that request. As one example only, if a user orally requested the system to obtain a list of received e-mails pertaining to a particular topic, then the multimodal server 50 which would be an e-mail server, would generate a list of received emails about the requested topic as its response.

Each of the corresponding DAs 46 receives the response from the corresponding multimodal server 50 and converts the response into an XML page using known XML page generation techniques. Then each of the corresponding DAs 46 transmits the XML page with channel ID information to the server page 42 through the corresponding message queues 44. The channel ID information identifies the channel type or modality type that is processed in the corresponding DA 46. Channel ID information identifies a channel ID of each modality which is assigned to each DA as the server page resources. It also identifies the modality type to which the DA is assigned. The modality type may be preassigned and the channel ID numbering can be either preassigned or dynamic as long as the server page 42 keeps an updated record of the channel ID information.

The server page 42 receives all returned information as the response of the multimodal interaction from all related DAs 46. These pieces of the interaction response information, which can be represented in the format of XML pages, are received with the channel ID information and type of modality it pertains to. The server page 42 then integrates or compiles all the received interaction responses into a joint response or joint event which can also be in the form of a joint XML page. This can be achieved by using the server side scripting or programming to combine and filter the received information from the multiple DAs 46, or by integrating these responses to form a joint multimodal interaction event based on multiple inputs from the different multimodal servers 50. According to another embodiment, the joint event can be formed at the VoiceXML interpreter 20.

The joint response is then communicated to the user or other designated device in accordance with the user's request through known techniques, e.g., via the APIs 60, message queues, HTTP 66, client's server, etc.

The server page 42 also communicates with the dialogue applications 10 (e.g., through the web server 30) to generate new instructions for any follow-up interaction which may accompany the response. If the follow-up interaction involves the voice channel, the server page 42 will generate a new VoiceXML page and make it available to the VoiceXML interpreter 20 through the web server 30, in which the desired interaction through the voice channel is properly described using the corresponding VoiceXML language. The VoiceXML interpreter 20 interprets the new VoiceXML page and instructs the platform to execute the desired voice channel interaction. If the follow-up interaction does not involve the voice channel, then it would be processed by other components such as the message queues 64 and the HTTP 66.

Due to the specific layout of the system 100 or 100a, one of the important features of the hybrid construct 40 is that it can be exposed as a distributed multimodal interaction resource and is not tied to any specific platform. Once it is constructed, it can be hosted and shared by different processes or different platforms.

As an example only, it is discussed below one application of the system 100 to perform email management when two modality channels are used. In this example, the two modality channels are voice and email. If a user speaks a voice command such as “please open and read my e-mail” into a known client device, then this request from the voice channel is processed at the Application API 60, which in turn communicates this request to the VoiceXML interpreter 20. The VoiceXML interpreter 20 under control of the dialogue applications 10 then recognizes that the current request involves opening a second modality channel (e-mail channel), and submits the email channel request to the web server 30.

The server page 42 is then activated and packages the request with related information (e.g., email account name, etc.) in a message and sends the message through the synchronizing module 44 to one of its email channel DAs 46 to execute it. The e-mail channel DA 46 interacts with the corresponding e-mail server 50 and accesses the requested e-mail content from the e-mail server 50. Once the email content is extracted by the email channel DA 46 as the result of the email channel interaction, the extracted e-mail content is transmitted to the server page 42 through the synchronizing module 44. The server page 42 in turn generates a VoiceXML page which contains the email content as well as the instructions to the VoiceXML interpreter 20 on how to read the e-mail content through the voice channel as a follow-up voice channel interaction. Obviously, this example can be modified or expanded to provide cross-channel multimodal interaction. In such a case, instead of providing instructions to the VoiceXML interpreter 20 on how to read the e-mail content through the voice channel, the server page 42 would provide instructions to send an e-mail to the designated e-mail address which carries the extracted e-mail content. Accordingly, using a single modality (voice channel in this example), multiple modality channels can be activated and used to conduct multimodal interaction of various types.

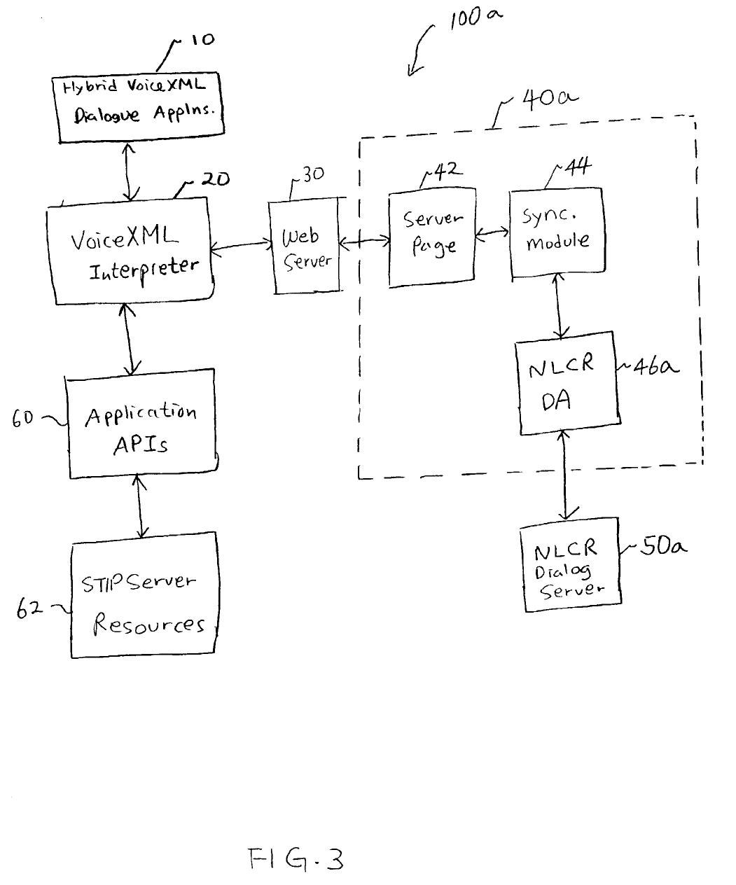

FIG. 3 shows a diagram of a dialogue system 100a which corresponds to the dialogue system 100 of FIG. 1 that has been applied to integrate natural language dialogue and finite-state dialogue as two modalities according to one embodiment of the present invention. Natural language dialogue and finite-state dialogue are two different types of dialogues. Existing VoiceXML programs are configured to support only the finite-state dialogue. Finite-state dialogue is a limited computer-recognizable dialogue which must follow certain grammatical sequences or rules for the computer to recognize. On the other hand, natural language dialogue is an everyday dialogue spoken naturally by a user. A more complex computer system and program is needed for machines to recognize the natural language dialogue.

Referring to FIG. 3, the system 100a contains components of the system 100 as indicated by the same reference numerals and thus, these components will not be discussed in detail.

The system 100a is capable of integrating not only multiple different physical modalities but also capable of integrating different interactions or processes as special modalities in a joint multimodal dialogue interaction. In this embodiment, two types of voice dialogues (i.e., finite-state dialogue as defined in VoiceXML and natural language dialogue which is not defined in VoiceXML) are treated as two different modalities. The interaction is through the voice channel but it is a mix of two different types (or modes) of dialogue. When the natural language dialogue is called (e.g., by the oral communication of the user), the system 100a recognizes that a second modality (natural language dialogue) channel needs to be activated. This request is submitted to the web server 30 for the natural language dialogue interaction through the VoiceXML interpreter 20 over the same voice channel used for the finite-state dialogue.

The server page 42 of a hybrid construct 40a packages the request and send it as a message to a natural language call routing DA (NLCR DA) 46a. A NLCR dialogue server 50a receives a response from the designated NLCR DA 46a with follow-up interaction instructions. A new VoiceXML page is then generated that instructs the VoiceXML interpreter 20 to interact according to the NLCR DA 46a. As this process continues, the dialogue control is shifted from VoiceXML to the NLCR DA 46a. The same voice channel and the same VoiceXML interpreter 20 are used to provide both natural language dialogue and finite-state dialogue interactions. But the role has been changed and the interpreter 20 acts as a slave process controlled and handled by the NLCR DA 46a. In the similar setting, the same approach applies to other generic cases involves multiple modalities and multiple processes.

As one example of implementation, <object> tag extensions can be used to allow the VoiceXML interpreter 20 to recognize the natural language speech. The <object> tag extensions are known VoiceXML programming tools that can be used to add new platform functionalities to the existing VoiceXML system.

The system 100a can be configured such that the finite-state dialogue interaction is the default to the alternative, natural language dialogue interaction. In this case, the system would first engage automatically in the finite-state dialogue interaction mode, until it determines that the received dialogue corresponds to the natural language dialogue and requires the activation of the natural language dialogue interaction mode.

It should be noted that the system 100a can also be integrated into the dialogue system 100 of FIG. 1 such that the natural language dialogue interaction can be one of many multimodal interactions possible by the system 100. For instance, the NLCR DA 46a can be one of the DAs 46 in the system 100, and the NLCR dialogue server 50a can be one of the multimodal servers 50 in the system 100. Other modifications can be made to provide this configuration.

The components of the dialogue systems shown in FIGS. 1 and 3 can reside all at a client side, or all at a server side, or across the server and client sides. Further, these components may communicate with each other and/or other devices over known networks such as internet, intranet, extranet, wired network, wireless network, etc. or over any combination of the known networks.

The present invention can be implemented using any known hardware and/or software. Such software may be embodied on any computer-readable medium. Any known computer programming language can be used to implement the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed:

1. A distributed multimodal interaction system comprising:
an application interface receiving a multimodal interaction request for conducting a multimodal interaction over at least two different modality channels; and
at least one hybrid construct communicating with multimodal servers corresponding to the modality of channels to execute the multimodal interaction request.

2. The system of claim 1, wherein the system is a hybrid voice extensible markup language (VoiceXML) system including one or multiple hybrid constructs.

3. The system of claim 1, wherein the hybrid construct receives responses to the multimodal interaction request from the multiple modality channels, and compiles a joint event response based on the responses from each individual modality, and transmits the joint event response to the application interface to conduct the multimodal interaction.

4. The system of claim 3, wherein the joint event response is compiled in the form of an extensible markup language (XML) page.

5. The system of claim 1, wherein the at least two modality channels include a voice channel, and the system further comprises an interpreter and a web server for processing voice dialogue over the voice channel.

6. The system of claim 1, wherein the hybrid construct includes:
a server page communicating with the application interface or a voice browser;
at least one synchronizing modules distributing the multimodal interaction request to the appropriate multimodal servers over the different modality channels; and
at least one dialogue agent communicating the multimodal interaction request with the appropriate multimodal servers, receiving the responses from the multimodal servers, and delivering the responses to the server page.

7. The system of claim 1, wherein the at least two modality channels include different types of voice dialogue channels.

8. The system of claim 7, wherein the types of voice dialogue channels include a natural language dialogue channel and a finite-state dialogue channel.

9. The system of claim 1, wherein the at least two modality channels include at least two of the following: voice, e-mail, fax, web-form, and web chat.

10. The system of claim 1, wherein the system conducts the multimodal interaction over at least the two modality channels, simultaneously and in parallel.

11. A method of providing distributed multimodal interaction in a dialogue system, the dialogue system including an application interface and at least one hybrid construct, the method comprising:
receiving, by the application interface, a multimodal interaction request for conducting a multimodal interaction over at least two different modality channels; and
communicating, by the hybrid construct, with multimodal servers corresponding to the modality channels to execute the multimodal interaction request.

12. The method of claim 11, wherein the dialogue system is a hybrid voice extensible markup language (VoiceXML) system with one or multiple hybrid constructs.

13. The method of claim 11, wherein the communicating step includes:
receiving, by the hybrid construct, responses to the multimodal interaction request from the modality channels;
compiling a joint event response based on the responses; and
transmitting the joint event response to the application interface to conduct the multimodal interaction.

14. The method of claim 13, wherein the joint event response is compiled in the form of an extensible markup language (XML) page.

15. The method of claim 11, wherein the at least two modality channels include a voice channel, and the method further comprises processing voice dialogue over the voice channel.

16. The method of claim 11, wherein the communicating step includes:
communicating by a server page with the application interface or a voice browser;
distributing the multimodal interaction request to the appropriate multimodal servers over the modality channels using at least one synchronizing module; and
communicating the multimodal interaction request with the appropriate multimodal servers using at least one dialogue agent, receiving the responses from the multimodal servers, and delivering the responses to the server page.

17. The method of claim 11, wherein the at least two modality channels include different types of voice dialogue channels.

18. The method of claim 17, wherein the types of voice dialogue channels include a natural language dialogue channel and a finite-state dialogue channel.

19. The method of claim 11, wherein the at least two modality channels include at least two of the following: voice, e-mail, fax, web-form, and web chat.

20. The method of claim 11, wherein the multimodal interaction is conducted over at least the two modality channels, simultaneously and in parallel.

21. A computer program product embodied on computer-readable media, for providing distributed multimodal interaction in a dialogue system, the dialogue system including an application interface and at least one hybrid construct, the computer program product comprising computer-executable instructions for;
receiving, by the application interface, a multimodal interaction request for conducting a multimodal interaction over at least two different modality channels; and
communicating, by the hybrid construct, with multimodal servers corresponding to the modality channels to execute the multimodal interaction request.

22. The computer program product of claim 21, wherein the dialogue system is a hybrid voice extensible markup language (VoiceXML) system with one or multiple hybrid constructs.

23. The computer program product of claim 21, wherein the computer-executable instructions for communicating include computer-executable instructions for:
receiving, by the hybrid construct, responses to the multimodal interaction request from the modality channels;
compiling a joint event response based on the responses; and
transmitting the joint event response to the application interface to conduct the multimodal interaction.

24. The computer program product of claim 23, wherein the joint event response is compiled in the form of an extensible markup language (XML) page.

25. The computer program product of claim 21, wherein the at least two modality channels include a voice channel, and the computer program product further comprises computer-executable instructions for processing voice dialogue over the voice channel.

26. The computer program product of claim 21, wherein the computer-executable instructions for communicating include computer-executable instructions for:
communicating by a server page with the application interface or a voice browser;
distributing the multimodal interaction request to the appropriate multimodal servers over the modality channels using at least one synchronizing module; and
communicating the multimodal interaction request with the appropriate multimodal servers using at least one dialogue agent, receiving the responses from the multimodal servers, and delivering the responses to the server page.

27. The computer program product of claim 21, wherein the at least two modality channels include different types of voice dialogue channels.

28. The computer program product of claim 27, wherein the types of voice dialogue channels include a natural language dialogue channel and a finite-state dialogue channel.

29. The computer program product of claim 21, wherein the at least two modality channels include at least two of the following: voice, e-mail, fax, web-form, and web chat.

30. The computer program product of claim 21, wherein the multimodal interaction is conducted over at least the two modality channels, simultaneously and in parallel.
